(19) United States
(12) Patent Application Publication
(10) Pub. No.: US 2017/0017129 A1
(43) Pub. Date: Jan. 19, 2017

(54) DISPLAY PANEL AND THIN FILM TRANSISTOR ARRAY SUBSTRATE

(71) Applicant: WUHAN CHINA STAR OPTOELECTRONICS TECHNOLOGY CO., LTD., Wuhan, Hubei (CN)

(72) Inventors: Mang ZHAO, Shenzhen, Guangdong (CN); Yong TIAN, Shenzhen, Guangdong (CN); Shijuan YI, Shenzhen, Guangdong (CN)

(21) Appl. No.: 14/777,984

(22) PCT Filed: Jul. 31, 2015
(86) PCT No.: PCT/CN2015/085753

§ 371 Date: Sep. 17, 2015

(30) Foreign Application Priority Data
Jul. 16, 2015 (CN) 20151041859.X

(51) Int. Cl. G02F 1/1362; G02F 1/1343; G02F 1/1333; G02F 1/1368; G02F 1/1335

(52) U.S. Cl. CPC G02F 1/136204; G02F 1/1368; G02F 1/133514; G02F 1/133512; G02F 1/133345; G02F 1/136286; G02F 1/134309; G02F 2201/123; G02F 2001/13629

(57) ABSTRACT

A display panel and thin film transistor array substrate are provided. The thin film transistor array substrate includes an active area and a peripheral region. The thin film transistor array substrate further includes a base substrate, a light shield metal layer, a first insulating layer, a semiconductor layer, a second insulating layer, a first signal line layer, a second signal line layer, a third signal line layer, a third insulating layer, a fourth insulating layer, a common line layer, a fifth insulating layer, and a pixel electrode layer. The present invention prevents display failure problems caused by the signal line being disconnected.

### FIELD OF THE INVENTION

The present invention relates to the field of display technologies, and more particularly to a display panel and a thin film transistor array substrate.

### BACKGROUND OF THE INVENTION

For a conventional display panel, a signal line layer of a thin film transistor array substrate is generally a single metal layer.

The anti-ESD (Electro Static Discharge) ability of the single metal layer is poor. Furthermore, when a larger electrostatic occurs in the thin film transistor array substrate, the single metal layer is easily fusible, so that display failure occurs in a partial region of the thin film transistor array substrate.

Therefore, it is necessary to provide a new technical solution to solve the above problems.

### SUMMARY OF THE INVENTION

An object of the present invention is to provide a display panel and thin film transistor array substrate which can prevent display failure problems caused by the signal line being disconnected.

In order to solve the aforementioned drawbacks of the prior art, the present invention provides a technical solution comprising:

a display panel, comprising a color filter substrate, a liquid crystal layer, and a thin film transistor array substrate. The thin film transistor array substrate comprises a base substrate, a light shield metal layer disposed on the base substrate, a first insulating layer, a semiconductor layer disposed on the first insulating layer, a second insulating layer disposed on the first insulating layer and the semiconductor layer, a first signal line layer disposed on the second insulating layer, a third insulating layer disposed on the second insulating layer and the first signal line layer, a second signal line layer disposed on the third insulating layer, and connected with the semiconductor layer via a first through hole, a fourth insulating layer disposed on the third insulating layer and the second signal line layer, a common line layer disposed on the fourth insulating layer, a third signal line layer, a fifth insulating layer disposed on the third signal line layer, and a pixel electrode layer disposed on the fifth insulating layer. The light shield metal layer is connected with the second signal line layer via a connecting member. The light shield metal layer is adapted for shielding a back channel of an N-channel metal oxide semiconductor transistor and for reducing current leakage of N-channel metal oxide semiconductor devices. The light shield metal layer is formed of the same metal material as the second signal line layer.

In the display panel described above, the connecting member is disposed in a through hole, the through hole passes through the first insulating layer, the second insulating layer, and the third insulating layer.

In the display panel described above, a second signal line of the second signal line layer comprises: at least one first section and at least one second section. A shading line of the light shield metal layer comprises: at least one third section and at least one fourth section, and the connecting member comprises: at least one first sub-connecting member and at least one second sub-connecting member. The first section is connected with the third section via the first sub-connecting member, and the second section is connected with the fourth section via the second sub-connecting member.

In the display panel described above, an end of the connecting member comprises a bending portion which is connected with the light shield metal layer and/or the second signal line layer.

The present invention further provides a display panel, comprising: a color filter substrate, a liquid crystal layer, and a thin film transistor array substrate. The thin film transistor array substrate comprises a base substrate, a light shield metal layer disposed on the base substrate, a first insulating layer, a semiconductor layer disposed on the first insulating layer, a second insulating layer disposed on the first insulating layer and the semiconductor layer, a first signal line layer disposed on the second insulating layer, a third insulating layer disposed on the second insulating layer and the first signal line layer, a second signal line layer disposed on the third insulating layer, and connected with the semiconductor layer via a first through hole, a fourth insulating layer disposed on the third insulating layer and the second signal line layer, a common line layer disposed on the fourth insulating layer, a third signal line layer, a fifth insulating layer disposed on the third signal line layer, and a pixel electrode layer disposed on the fifth insulating layer.

In the display panel described above, the light shield metal layer is connected with the second signal line layer via a connecting member.

In the display panel described above, the connecting member is disposed in a through hole, the through hole passes through the first insulating layer, the second insulating layer, and the third insulating layer.

In the display panel described above, the through hole is formed by etching with a photomask the first insulating layer, the second insulating layer, and the third insulating layer.

In the display panel described above, a second signal line of the second signal line layer comprises at least one first section and at least one second section. A shading line of the light shield metal layer comprises at least one third section and at least one fourth section. The connecting member comprises at least one first sub-connecting member and at least one second sub-connecting member. The first section is connected with the third section via the first sub-connecting member, and the second section is connected with the fourth section via the second sub-connecting member.

In the display panel described above, the second signal line of the second signal line layer and the shading line of the light shield metal layer are connected in parallel, a connection point is disposed at a predetermined distance from the second signal line and the second signal line.

In the display panel described above, an end of the connecting member comprises a bending portion which is connected with the light shield metal layer and/or the second signal line layer.

In the display panel described above, the connecting member comprises a first end and a second end. The first end is connected with the light shield metal layer, and the first end includes a first bending portion which extends toward a direction away from the connecting member. The second end is connected with the second signal line layer, and the second end includes a second bending portion which extends toward a direction away from the connecting member.

The present invention further provides a thin film transistor array substrate, which comprises: a base substrate, a light shield metal layer disposed on the base substrate, a first insulating layer, a semiconductor layer disposed on the first insulating layer, a second insulating layer disposed on the first insulating layer and the semiconductor layer, a first signal line layer disposed on the second insulating layer, a third insulating layer disposed on the second insulating layer and the first signal line layer, a second signal line layer disposed on the third insulating layer and connected with the semiconductor layer via a first through hole, a fourth insulating layer disposed on the third insulating layer and the second signal line layer, a common line layer disposed on the fourth insulating layer, a third signal line layer, a fifth insulating layer disposed on the third signal line layer, and a pixel electrode layer disposed on the fifth insulating layer.

In the thin film transistor array substrate described above, the light shield metal layer is connected with the second signal line layer via a connecting member.

In the thin film transistor array substrate described above, the connecting member is disposed in a through hole, and the through hole passes through the first insulating layer, the second insulating layer, and the third insulating layer.

In the thin film transistor array substrate described above, the through hole is formed by etching with a photomask the first insulating layer, the second insulating layer, and the third insulating layer.

In the thin film transistor array substrate described above, a second signal line of the second signal line layer comprises at least one first section and at least one second section. A shading line of the light shield metal layer comprises at least one third section and at least one fourth section. The connecting member comprises at least one first sub-connecting member and at least one second sub-connecting member. The first section is connected with the third section via the first sub-connecting member, the second section is connected with the fourth section via the second sub-connecting member.

In the thin film transistor array substrate described above, the second signal line of the second signal line layer and the shading line of the light shield metal layer are connected in parallel, and a connection point is disposed at a predetermined distance from the second signal line and the second signal line.

In the thin film transistor array substrate described above, an end of the connecting member comprises a bending portion which is connected with the light shield metal layer and/or the second signal line layer.

In the thin film transistor array substrate described above, the connecting member comprises a first end and a second end. The first end is connected with the light shield metal layer, and the first end includes a first bending portion which extends toward a direction away from the connecting member. The second end is connected with the second signal line layer, and the second end includes a second bending portion which extends toward a direction away from the connecting member.

Compared to the prior art, the present invention can prevent display failure problems caused via the signal line being disconnected and further can improve the yield rate of the products.

The present invention can be more fully understood by reading the subsequent detailed description and examples with references made to the accompanying drawings.

### DESCRIPTION OF THE DRAWINGS

FIG. 1 is a schematic diagram illustrating partition of a thin film transistor array substrate of the present invention;

FIG. 2 is a schematic diagram of a thin film transistor array substrate of the present invention;

FIG. 3 is a schematic diagram of circuits of a peripheral region of the thin film transistor array substrate of the present invention;

FIG. 4 is a schematic cross-section of line A-A′ according to FIG. 3 of the present invention; and

FIG. 5 is a schematic cross-section of line B-B′ according to FIG. 3 of the present invention.

### DETAILED DESCRIPTION OF THE PREFERRED EMBODIMENTS

Reference throughout this specification to “one embodiment” or “an embodiment” means that a particular feature, structure, or characteristic described in connection with the embodiment is included in at least one embodiment of the present invention. It is noted here that, as used in this specification and the appended claims, the singular forms “a”, “an”, and “the” include the plural unless the context clearly dictates otherwise. In addition, the articles “a” and “an” as used in this application and the appended claims should generally be construed to mean “one or more” unless specified otherwise or clear from the context to be directed to a singular form.

A display panel of the present invention can be a Thin Film Transistor Liquid Crystal Display (TFT-LCDT).

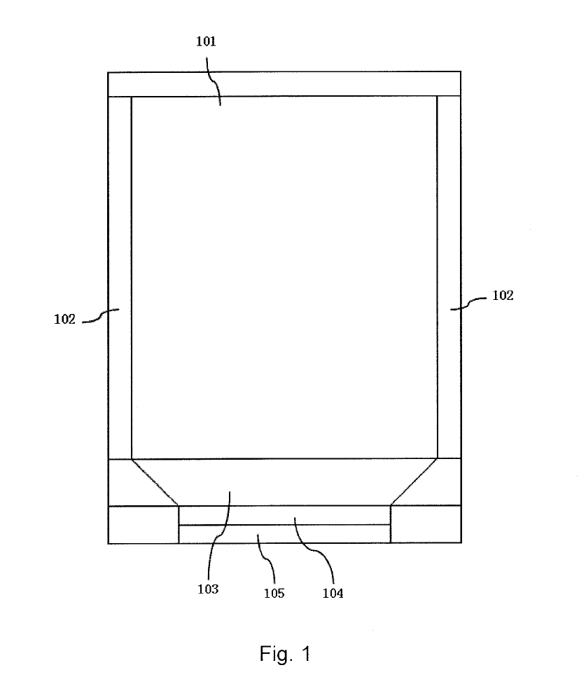

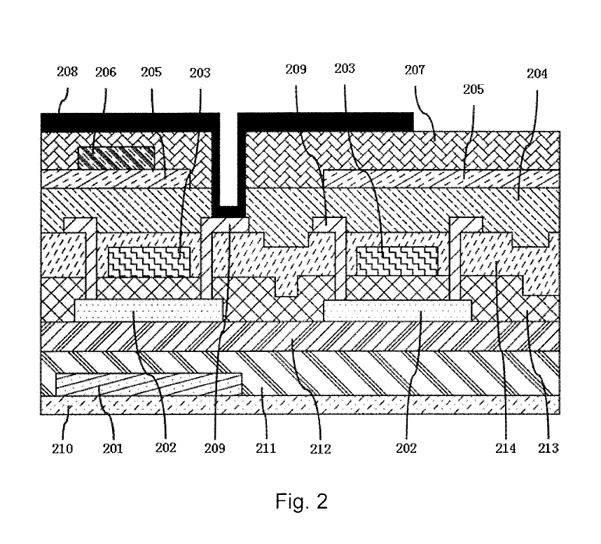

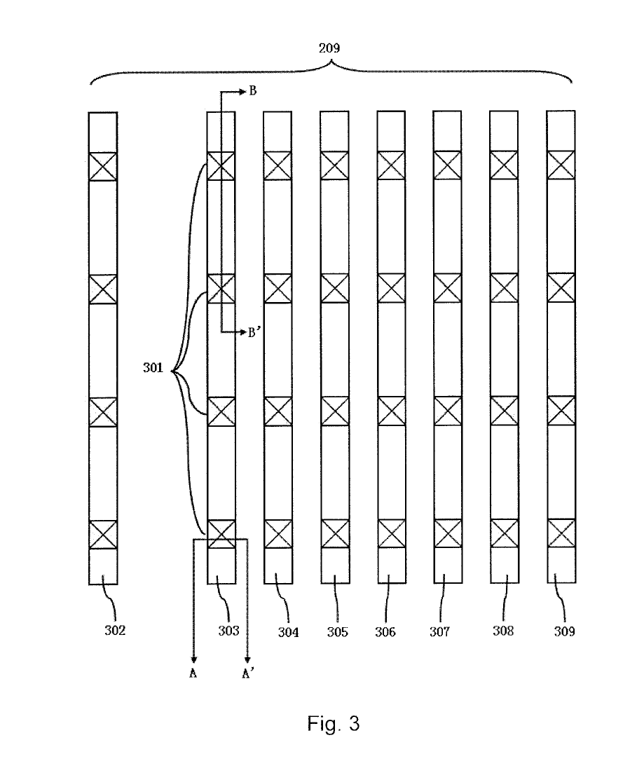

Refer to FIGS. 1-3. FIG. 1 is a schematic diagram illustrating partition of a thin film transistor array substrate of the present invention, FIG. 2 is a schematic diagram of a thin film transistor array substrate of the present invention, and FIG. 3 is a schematic diagram of circuits of a peripheral region of the thin film transistor array substrate of the present invention.

The display panel of the present invention comprises a color filter substrate, a liquid crystal layer, and a thin film transistor array substrate. The color filter substrate and the thin film transistor array substrate are superimposed and combined for forming a liquid crystal cell. The liquid crystal layer is disposed within the liquid crystal cell.

The thin film transistor array substrate comprises an active area (AA) 101 and a peripheral region. The peripheral region is disposed on at least one side of the active area.

The peripheral region comprises at least one of the following group consisting of a Gate-driver On Array (GOA) area 102 where a scan driver integrated, a Fan-out area 103, an Integrated Circuit (IC) area 104, and a Flexible Printed Circuit (FPCF) area 105.

In addition, a gate drive signal from the GOA area 102 is transmitted to a thin film transistor (TFT) of the display panel. A trace for coupling an integrated circuit on the IC area 104 and a data line of the active area 101 is configured on the Fan-out area 103. An integrated circuit is bonded on the IC area 104. Then, circuits and the thin film transistor within the display panel are driven by the integrated circuit. A flexible printed circuit is bonded on the FPC area 105 and is connected with a main board of the display panel.

The thin film transistor array substrate further comprises a base substrate 210, a light shield metal layer 201, a protective layer (buffer layer) 211, a first insulating layer 212, a semiconductor (polysilicon) layer 202, a second insulating layer 213, a first signal line layer 203, a third insulating layer 214, a second signal line layer 209, a fourth insulating layer 204, a common line layer 205, a third signal line layer 206, a fifth insulating layer 207, and a pixel electrode layer 208.

Moreover, the light shield metal layer 201 is disposed on the base substrate 210. The light shield metal layer 201 is adapted for shielding a back channel of an N-channel metal oxide semiconductor (N-MOS) transistor and for reducing current leakage of N-channel metal oxide semiconductor (N-MOS) devices. The buffer layer 211 is disposed on the base substrate 210 and the light shield metal layer 201. The semiconductor layer 202 is disposed on the first insulating layer 212. The second insulating layer 213 is disposed on the first insulating layer 212 and the semiconductor layer 202. The first signal line layer 203 is disposed on the second insulating layer 213. A first signal line of the first signal line layer 203 can be a scanning line. The third insulating layer 214 is disposed on the second insulating layer 213 and the first signal line layer 203. The second signal line layer 209 is disposed on the third insulating layer 214, and the second signal line layer 209 is connected with the semiconductor layer 202 via a first through hole. The fourth insulating layer 204 is disposed on the third insulating layer 214 and the second signal line layer 209. The common line layer 205 is disposed on the fourth insulating layer 204. The fifth insulating layer 207 is disposed on the third signal line layer 206. Besides, a third signal line of the third signal line layer 206 can be a touch sensing line. The pixel electrode layer 208 is disposed on the fifth insulating layer 207.

Furthermore, a material of the light shield metal layer 201 and a material of the second signal line layer 209 are both conductive materials. For example, the light shield metal layer 201 is formed of the same metal material as the second signal line layer 209.

The GOA area 102 of the thin film transistor array substrate comprises a ground line (GND) 302, a stage transfer signal line (STV) 303, a first scan direction controlling signal line (U2D) 304, a second scan direction controlling signal line (D2U) 305, clock signal lines (CK) 306, 307, a first voltage gate line (VGH) 308, a second voltage gate line (VGL) 309, and the like. In the GOA area 102, a second signal line of the second signal line layer 209 can be selected from one of the group consisting of the ground line 302, the stage transfer signal line 303, the first scan direction controlling signal line 304, the second scan direction controlling signal line 305, the clock signal lines 306, 307, the first voltage gate line 308, and the second voltage gate line 309. In the active area, the second signal line can be a data line.

In addition, the ground line 302 is configured for electrostatic protection. The stage transfer signal line 303 is configured for providing an initiation signal to the GOA circuit of the thin film transistor. The first scan direction controlling signal line 304 and the second scan direction controlling signal line 305 are configured for controlling a scan direction of the GOA circuit. The clock signal lines 306, 307 are configured for generating and controlling gate shifted signals. The first voltage gate line 308 and the second voltage gate line 309 are configured for providing voltage to the GOA circuit.

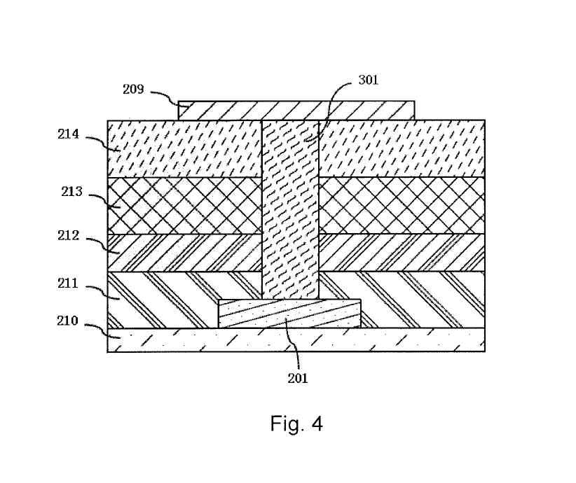

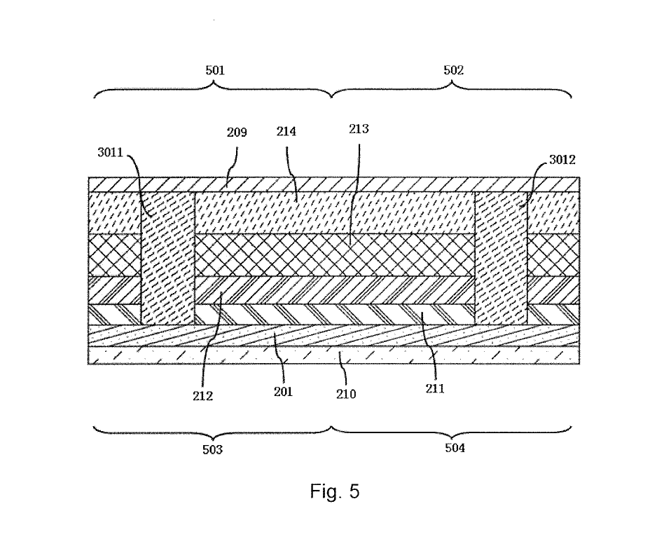

Refer to FIGS. 4-5. FIG. 4 is a schematic cross-section of line A-A′ according to FIG. 3 of the present invention and FIG. 5 is a schematic cross-section of line B-B′ according to FIG. 3 of the present invention.

In the preferred embodiment of the present invention, the light shield metal layer 201 is connected with the second signal line layer 209 via a connecting member 301.

In the preferred embodiment of the present invention, the connecting member 301 is disposed in a through hole, and the through hole passes through the first insulating layer 212, the second insulating layer 213 and the third insulating layer 214. The through hole is formed by etching with a photomask the first insulating layer 212, the second insulating layer 213, and the third insulating layer 214.

In the technical solution described above, the light shield metal layer 201 is connected with the second signal line layer 209 via the connecting member 301. Thus, when the second signal line of the second signal line layer 209 is disconnected, i.e., the second signal line is broken into at least two parts, two parts of the broken second signal line still can connect with each other via the light shield metal layer 201, which can greatly reduce the probability of disconnection of signal lines (the second signal line), and can solve the problem of display failure caused by the disconnection of signal lines. Therefore, the yield rate of the products can be improved.

Furthermore, the technical solution described above further can reduce the impedance of the whole signal lines (the second signal line), and can improve the ability of anti ESD of the signal lines.

The second embodiment of the present invention is similar to the first embodiment described above, except that:

in the preferred embodiment of the present invention, the second signal line of the second signal line layer 209 comprises at least one first section 501 and at least one second section 502.

A shading line of the light shield metal layer 201 comprises at least one third section 503 and at least one fourth section 504.

The connecting member 301 comprises at least one first sub-connecting member 3011 and at least one second sub-connecting member 3012.

The first section 501 is connected with the third section 503 via the first sub-connecting member 3011, and the second section 502 is connected with the fourth section 504 via the second sub-connecting member 3012.

Namely, in the preferred embodiment of the present invention, the second signal line of the second signal line layer 209 and the shading line of the light shield metal layer 201 are connected in parallel, and a connection point is disposed at a predetermined distance from the second signal line and the second signal line.

The second embodiment of the present invention can greatly reduce the probability of disconnection of the second signal line, and can reduce the impedance of the second signal line, further can improve the ability of anti ESD of the thin film transistor array substrate.

The third embodiment of the present invention is similar to the second embodiment described above, except that:

in the preferred embodiment of the present invention, an end of the connecting member 301 comprises a bending portion which is connected with the light shield metal layer 201 and/or the second signal line layer 209.

Specifically, the connecting member 301 comprises a first end and a second end. The first end is connected with the light shield metal layer 201, and the second end is connected with the second signal line layer 209. The first end includes a first bending portion which extends toward a direction away from the connecting member 301, and the second end includes a second bending portion which extends toward a direction away from the connecting member 301.

The technical solution described above is beneficial in expanding a contact area of the connecting member 301 and the light shield metal layer 201 and/or the second signal line layer 209, so that contact failure can be prevented between the connecting member 301 and the light shield metal layer 201 and/or the second signal line layer 209.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification is intended to embrace all such alterations, modifications, and variations that fall within the spirit and scope of the appended claims. In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods. In addition, while a particular feature may have been disclosed with respect to only one of several implementations, such a feature may be combined with one or more other features of the other implementations as may be desired and advantageous for any given or particular application. To the extent that the terms “includes” and “including” and variants thereof are used in either the detailed description or the claims, these terms are intended to be inclusive in a manner similar to the term “comprising.” Furthermore, the term “or” as used in either the detailed description or the claims is meant to be a “non-exclusive or”.

The present invention has been described with preferred embodiments thereof, and it is understood that many changes and modifications to the described embodiments can be carried out without departing from the scope and the spirit of the invention that is intended to be limited only by the appended claims.

What is claimed is:

1. A display panel, comprising:
a color filter substrate;
a liquid crystal layer; and
a thin film transistor array substrate, comprising:
a base substrate;
a light shield metal layer, disposed on the base substrate;
a first insulating layer;
a semiconductor layer, disposed on the first insulating layer;
a second insulating layer, disposed on the first insulating layer and the semiconductor layer;
a first signal line layer, disposed on the second insulating layer;
a third insulating layer, disposed on the second insulating layer and the first signal line layer;
a second signal line layer, disposed on the third insulating layer, and connected with the semiconductor layer via a first through hole;
a fourth insulating layer, disposed on the third insulating layer and the second signal line layer;
a common line layer disposed on the fourth insulating layer;
a third signal line layer;
a fifth insulating layer disposed on the third signal line layer;
a pixel electrode layer disposed on the fifth insulating layer;
the light shield metal layer being connected with the second signal line layer via a connecting member;
the light shield metal layer being adapted for shielding a back channel of an N-channel metal oxide semiconductor transistor and for reducing current leakage of N-channel metal oxide semiconductor devices;
the light shield metal layer being formed of the same metal material as the second signal line layer.

2. The display panel according to claim 1, wherein the connecting member is disposed in a through hole;
the through hole passes through the first insulating layer, the second insulating layer and the third insulating layer.

3. The display panel according to claim 1, wherein a second signal line of the second signal line layer comprises:
at least one first section;
at least one second section; and
a shading line of the light shield metal layer comprises:
at least one third section;
at least one fourth section; and
the connecting member comprises:
at least one first sub-connecting member; and
at least one second sub-connecting member;
wherein the first section connected with the third section via the first sub-connecting member, the second section connected with the fourth section via the second sub-connecting member.

4. The display panel according to claim 1, wherein an end of the connecting member comprises a bending portion which is connected with the light shield metal layer and/or the second signal line layer.

5. A display panel, comprising:
a color filter substrate;
a liquid crystal layer; and
a thin film transistor array substrate, comprising:
a base substrate;
a light shield metal layer, disposed on the base substrate;
a first insulating layer;
a semiconductor layer, disposed on the first insulating layer;
a second insulating layer, disposed on the first insulating layer and the semiconductor layer;
a first signal line layer, disposed on the second insulating layer;
a third insulating layer, disposed on the second insulating layer and the first signal line layer;
a second signal line layer disposed on the third insulating layer, and connected with the semiconductor layer via a first through hole;
a fourth insulating layer disposed on the third insulating layer and the second signal line layer;
a common line layer disposed on the fourth insulating layer;
a third signal line layer;
a fifth insulating layer disposed on the third signal line layer; and
a pixel electrode layer disposed on the fifth insulating layer.

6. The display panel according to claim 5, wherein the light shield metal layer is connected with the second signal line layer via a connecting member.

7. The display panel according to claim 6, wherein the connecting member is disposed in a through hole;
the through hole passes through the first insulating layer, the second insulating layer and the third insulating layer.

8. The display panel according to claim 7, wherein the through hole is formed by etching with a photomask the first insulating layer, the second insulating layer and the third insulating layer.

9. The display panel according to claim 6, wherein a second signal line of the second signal line layer comprises:
at least one first section;
at least one second section; and
a shading line of the light shield metal layer comprises:
at least one third section;
at least one fourth section; and
the connecting member comprises:
at least one first sub-connecting member; and
at least one second sub-connecting member;
wherein the first section connected with the third section via the first sub-connecting member, the second section connected with the fourth section via the second sub-connecting member.

10. The display panel according to claim 9, wherein the second signal line of the second signal line layer and the shading line of the light shield metal layer are connected in parallel, and a connection point is disposed at a predetermined distance from the second signal line and the second signal line.

11. The display panel according to claim 6, wherein an end of the connecting member comprises a bending portion which is connected with the light shield metal layer and/or the second signal line layer.

12. The display panel according to claim 11, wherein the connecting member comprises a first end and a second end;
the first end is connected with the light shield metal layer, the first end includes a first bending portion which extends toward a direction away from the connecting member;
the second end is connected with the second signal line layer, the second end includes a second bending portion which extends toward a direction away from the connecting member.

13. A thin film transistor array substrate, comprising:
a base substrate;
a light shield metal layer disposed on the base substrate;
a first insulating layer;
a semiconductor layer, disposed on the first insulating layer;
a second insulating layer disposed on the first insulating layer and the semiconductor layer;
a first signal line layer disposed on the second insulating layer;
a third insulating layer disposed on the second insulating layer and the first signal line layer;
a second signal line layer disposed on the third insulating layer, and connected with the semiconductor layer via a first through hole;
a fourth insulating layer disposed on the third insulating layer and the second signal line layer;
a common line layer disposed on the fourth insulating layer;
a third signal line layer;
a fifth insulating layer disposed on the third signal line layer; and
a pixel electrode layer disposed on the fifth insulating layer.

14. The thin film transistor array substrate according to claim 13, wherein the light shield metal layer is connected with the second signal line layer via a connecting member.

15. The thin film transistor array substrate according to claim 14, wherein the connecting member is disposed in a through hole;
the through hole passes through the first insulating layer, the second insulating layer and the third insulating layer.

16. The thin film transistor array substrate according to claim 15, wherein the through hole is formed by etching with a photomask the first insulating layer, the second insulating layer and the third insulating layer.

17. The thin film transistor array substrate according to claim 14, wherein a second signal line of the second signal line layer comprises:
at least one first section;
at least one second section; and
a shading line of the light shield metal layer comprises:
at least one third section;
at least one fourth section; and
the connecting member comprises:
at least one first sub-connecting member; and
at least one second sub-connecting member;
wherein the first section connected with the third section via the first sub-connecting member, the second section connected with the fourth section via the second sub-connecting member.

18. The thin film transistor array substrate according to claim 17, wherein the second signal line of the second signal line layer and the shading line of the light shield metal layer are connected in parallel, and a connection point is disposed at a predetermined distance from the second signal line and the second signal line.

19. The thin film transistor array substrate according to claim 14, wherein an end of the connecting member comprises a bending portion which is connected with the light shield metal layer and/or the second signal line layer.

20. The thin film transistor array substrate according to claim 19, wherein the connecting member comprises a first end and a second end;
the first end is connected with the light shield metal layer, the first end includes a first bending portion which extends toward a direction away from the connecting member;
the second end is connected with the second signal line layer, the second end includes a second bending portion which extends toward a direction away from the connecting member.
